(19) United States
(12) Patent Application Publication
(10) Pub. No.: US 2016/0055029 A1
(43) Pub. Date: Feb. 25, 2016

(54) Programmatic Decoupling of Task Execution from Task Finish in Parallel Programs

(71) Applicant: QUALCOMM Incorporated, San Diego, CA (US)

(72) Inventors: Arun Raman, Santa Clara, CA (US); Pablo Montesinos Ortego, Fremont, CA (US)

(21) Appl. No.: 14/604,821

(22) Filed: Jan. 26, 2015

Related U.S. Application Data
(60) Provisional application No. 62/040,177, filed on Aug. 21, 2014.

(51) Int. Cl. G06F 9/48

(52) U.S. Cl. CPC G06F 9/485; G06F 9/4881

(57) ABSTRACT

A computing device may be configured to commence or begin executing a first task via a first thread (e.g., in a first processor or core), begin executing a second task via a second thread (e.g., in a second processor or core), identify an operation of the second task as being dependent on the first task finishing execution, and change an operating state of the second task to “executed” prior to the first task finishing execution so as to allow the computing device to enforce task-dependencies while the second thread continues to process additional tasks. The computing device may begin executing a third task via the second thread (e.g., in a second processing core) prior to the first task finishing execution, and change the operating state of the second task to “finished” after the first task finishes.

### RELATED APPLICATIONS

This application claims the benefit of priority to U.S. Provisional Application No. 62/040,177, entitled “Programmatic Decoupling of Task Execution from Task Finish in Parallel Programs” filed Aug. 21, 2014, the entire contents of which is hereby incorporated by reference.

### BACKGROUND

Mobile and wireless technologies have seen explosive growth over the past several years. This growth has been fueled by better communications, hardware, and more reliable protocols. Wireless service providers are now able to offer their customers an ever-expanding array of features and services, and provide users with unprecedented levels of access to information, resources, and communications. To keep pace with these enhancements, mobile electronic devices (e.g., cellular phones, watches, headphones, remote controls, etc.) have become more complex than ever, and now commonly include multiple processors, system-on-chips (SoCs), and other resources that allow mobile device users to execute complex and power intensive software applications (e.g., video streaming, video processing, etc.) on their mobile devices.

Due to these and other improvements, smartphones and tablet computers have grown in popularity, and are replacing laptops and desktop machines as the platform of choice for many users. As mobile devices continue to grow in popularity, improved processing solutions that better utilize the multiprocessing capabilities of the mobile devices will be desirable to consumers.

### SUMMARY

The various embodiments include methods of executing tasks in a computing device, which may include commencing execution of a first task via a first thread of a thread pool in the computing device, commencing execution of a second task via a second thread of the thread pool, identifying an operation of the second task as being dependent on the first task finishing execution, commencing execution of a third task via the second thread prior to the first task finishing execution, and changing an operating state of the second task to “finished” by the first thread in response to determining that the first task has finished execution.

In an embodiment, the method may include changing the operating state of the second task to “executed” by the second thread in response to identifying the operation, prior to commencing execution of the third task, and prior to changing the operating state of the second task to “finished.” In a further embodiment, changing the operating state of the second task to “executed” in response to identifying the operation (prior to commencing execution of the third task and prior to changing the operating state of the second task to “finished”) may include changing the operating state of the second task in response to determining that the second task includes a finish_after operation, and after completing all other operations of the second task. In a further embodiment, the method may include creating a dummy task that depends on the first task in response to the second thread performing a finish_after operation of the second task. In a further embodiment, the method may include the dummy task performing a programmer-supplied function specified via a parameter of the finish_after operation.

In a further embodiment, the method may include launching a fourth task that is dependent on the second task, and commencing execution of the fourth task via the first thread in response to identifying the operation. In a further embodiment, commencing execution of the first task via the first thread of the thread pool may include executing the first task in a first processing core of the computing device, and commencing execution of the second task via the second thread of the thread pool may include executing the second task in a second processing core of the computing device concurrent with execution of the first task in the first processing core. In a further embodiment, the first and second threads may be different threads.

Further embodiments may include a computing device having one or more processors that are configured with processor-executable instructions to perform operations that include commencing execution of a first task via a first thread of a thread pool in the computing device, commencing execution of a second task via a second thread of the thread pool, identifying an operation of the second task as being dependent on the first task finishing execution, commencing execution of a third task via the second thread prior to the first task finishing execution, and changing an operating state of the second task to “finished” by the first thread in response to determining that the first task has finished execution.

In an embodiment, one or more of the processors may be configured with processor-executable instructions to perform operations that include changing the operating state of the second task to “executed” by the second thread in response to identifying the operation prior to commencing execution of the third task and prior to changing the operating state of the second task to “finished.” In a further embodiment, one or more of the processors may be configured with processor-executable instructions to perform operations such that changing the operating state of the second task to “executed” in response to identifying the operation prior to commencing execution of the third task and prior to changing the operating state of the second task to “finished” includes changing the operating state of the second task in response to determining that the second task includes a finish_after operation and after completing all other operations of the second task. In a further embodiment, one or more of the processors may be configured with processor-executable instructions to perform operations that include creating a dummy task that depends on the first task in response to the second thread performing a finish_after operation of the second task In a further embodiment, one or more of the processors may be configured with processor-executable instructions to perform operations that include the dummy task performing a programmer-supplied function specified via a parameter of the finish_after operation.

In a further embodiment, one or more of the processors may be configured with processor-executable instructions to perform operations that further include launching a fourth task that is dependent on the second task, and commencing execution of the fourth task via the first thread in response to identifying the operation. In a further embodiment, one or more of the processors may be configured with processor-executable instructions to perform operations such that commencing execution of the first task via the first thread of the thread pool includes executing the first task in a first processor of the computing device, and commencing execution of the second task via the second thread of the thread pool includes executing the second task in a second processor of the computing device concurrent with execution of the first task in the first processing core. In a further embodiment, one or more of the processors may be configured with processor-executable instructions to perform operations such that the first and second threads are different threads.

Further embodiments may include a non-transitory computer readable storage medium having stored thereon processor-executable software instructions configured to cause one or more processors in a computing device to perform operations that include commencing execution of a first task via a first thread of a thread pool in the computing device, commencing execution of a second task via a second thread of the thread pool, identifying an operation of the second task as being dependent on the first task finishing execution, commencing execution of a third task via the second thread prior to the first task finishing execution, and changing an operating state of the second task to “finished” by the first thread in response to determining that the first task has finished execution.

In an embodiment, the stored processor-executable software instructions may be configured to cause a processor to perform operations including changing the operating state of the second task to “executed” by the second thread in response to identifying the operation prior to commencing execution of the third task and prior to changing the operating state of the second task to “finished.” In a further embodiment, the stored processor-executable software instructions may be configured to cause a processor to perform operations such that changing the operating state of the second task to “executed” in response to identifying the operation prior to commencing execution of the third task and prior to changing the operating state of the second task to “finished” includes changing the operating state of the second task in response to determining that the second task includes a finish_after operation and after completing all other operations of the second task.

In a further embodiment, the stored processor-executable software instructions may be configured to cause a processor to perform operations that include creating a dummy task that depends on the first task in response to the second thread performing a finish_after operation of the second task. In a further embodiment, the stored processor-executable software instructions may be configured to cause a processor to perform operations that include the dummy task performing a programmer-supplied function specified via a parameter of the finish_after operation.

In a further embodiment, the stored processor-executable software instructions may be configured to cause a processor to perform operations such that commencing execution of the first task via the first thread of the thread pool includes executing the first task in a first processing core of the computing device, and commencing execution of the second task via the second thread of the thread pool includes executing the second task in a second processing core of the computing device concurrent with execution of the first task in the first processing core. In a further embodiment, the stored processor-executable software instructions may be configured to cause a processor to perform operations such that the first and second threads are different threads.

Further embodiments may include methods of compiling and executing software code. The software code may include a first code defining a first task, a second code defining a second task, and a statement that makes an operation of the second task dependent on the first task finishing execution, but enables a thread that commences execution of the second task to commence execution of a third task prior to the first task finishing execution. In an embodiment, executing the compiled software code may include executing the first code in a first processing core of a computing device and executing the second code in a second processing core of the computing device concurrent with execution of the first task in the first processing core. In a further embodiment, executing the compiled software code may include executing the first task via a first thread of a thread pool in a computing device and executing the second task via a second thread of the thread pool. In a further embodiment, the first and second threads may be different threads.

Further embodiments may include a computing device having one or more processors configured with processor-executable instructions to perform various operations corresponding to the methods described above. Further embodiments may include a non-transitory processor-readable storage medium having stored thereon processor-executable instructions configured to cause a processor to perform various operations corresponding to the methods operations described above.

### BRIEF DESCRIPTION OF THE DRAWINGS

The accompanying drawings, which are incorporated herein and constitute part of this specification, illustrate exemplary embodiment of the invention, and together with the general description given above and the detailed description given below, serve to explain the features of the invention.

FIG. 1 is an architectural diagram of an example system on chip suitable for implementing the various embodiments.

FIGS. 2A through 2C are illustrations of example prior art solutions for displaying data fetched from many remote sources.

FIGS. 3 through 7 are illustrations of procedures suitable for executing tasks in accordance with various embodiments.

FIGS. 8A and 8B are block diagrams illustrating state transitions of a task in accordance with various embodiments.

FIG. 9A is an illustration of a procedure that uses the finish_after statement to decouple task execution from task finish in accordance with an embodiment.

FIG. 9B is a timing diagram illustrating operations of the tasks of the procedure illustrated in FIG. 9A.

FIG. 10 is a process flow diagram illustrating a method of executing tasks in accordance with an embodiment.

FIG. 11 is a block diagram of an example laptop computer suitable for use with the various embodiments.

FIG. 12 is a block diagram of an example smartphone suitable for use with the various embodiments.

FIG. 13 is a block diagram of an example server computer suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

In overview, the various embodiments include methods, and computing devices configured to perform the methods, of using techniques that exploit the concurrency/parallelism enabled by modern multiprocessor architectures to generate and execute software applications in order to achieve fast response times, high performance, and high user interface responsiveness.

In the various embodiments, a computing device may be configured to begin executing a first task via a first thread (e.g., in a first processing core), begin executing a second task via a second thread (e.g., in a second processing core), identify an operation (i.e., a “finish_after” operation) of the second task as being dependent on the first task finishing execution, change an operating state of the second task to “executed” prior to the first task finishing execution, begin executing a third task via the second thread (e.g., in a second processing core) prior to the first task finishing execution, and change the operating state of the second task to “finished” after the first task finishes its execution. In some instances the first and second tasks may be part of the same thread, although in many instances the first and second tasks will be from different threads.

By changing the execution state of the second task to “executed” (as opposed to waiting for the first task to finish or to changing the state to “finished”) the various embodiments allow the computing device to enforce task-dependencies while the second thread continues to process additional tasks. These operations improve the functioning of the computing device by reducing the latencies associated with executing software applications on the device. These operations also improve the functioning of the computing device by improving its efficiency, performance, and power consumption characteristics.

The terms “computing system” and “computing device” are used generically herein to refer to any one or all of servers, personal computers, and mobile devices, such as cellular telephones, smartphones, tablet computers, laptop computers, netbooks, ultrabooks, palm-top computers, personal data assistants (PDA's), wireless electronic mail receivers, multimedia Internet enabled cellular telephones, Global Positioning System (GPS) receivers, wireless gaming controllers, and similar personal electronic devices which include a programmable processor. While the various embodiments are particularly useful in mobile devices, such as smartphones, which have limited processing power and battery life, the embodiments are generally useful in any computing device that includes a programmable processor.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may used herein to refer to a single module or package that contains multiple resources, computational units, cores and/or processors on two or more IC chips or substrates. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SOCs coupled together via high speed communication circuitry and packaged in close proximity, such as on a single motherboard or in a single mobile computing device. The proximity of the SOCs facilitates high speed communications and the sharing of memory and resources.

The term “multicore processor” is used herein to refer to a single integrated circuit (IC) chip or chip package that contains two or more independent processing cores (e.g., CPU core, IP core, GPU core, etc.) configured to read and execute program instructions. A SOC may include multiple multicore processors, and each processor in an SOC may be referred to as a core. The term “multiprocessor” is used herein to refer to a system or device that includes two or more processing units configured to read and execute program instructions.

The term “context information” is used herein to refer to any information available to a process or thread running in a host operating system (e.g., Android, Windows 8, LINUX, etc.). Context information may include operational state data, as well as permissions and/or access restrictions that identify the operating system services, libraries, file systems, and other resources that the process or thread may access.

In an embodiment, a process may be a software representation of a software application. Processes may be executed on a processor in short time slices so that it appears that multiple applications are running simultaneously on the same processor (e.g., by using time-division multiplexing techniques). When a process is removed from a processor at the end of a time slice, information pertaining to the current operating state of the process (i.e., the process's operational state data) is stored in memory so the process may seamlessly resume its operations when it returns to execution on the processor.

A process's operational state data may include the process's address space, stack space, virtual address space, register set image (e.g. program counter, stack pointer, instruction register, program status word, etc.), accounting information, permissions, access restrictions, and state information. The state information may identify whether the process is a running state, a ready or ready-to-run state, or a blocked state. A process is in the ready-to-run state when all of its dependencies or prerequisites for execution have been met (e.g., memory and resources are available, etc.), and is waiting to be assigned to the next available processing unit. A process is in the running state when its procedure is being executed by a processing unit. A process is in the blocked state when it is waiting for the occurrence of an event (e.g., input/output completion event, etc.).

A process may spawn other processes, and the spawned process (i.e., a child process) may inherit some of the permissions and access restrictions (i.e., context) of the spawning process (i.e., the parent process). A process may also be a heavy-weight process that includes multiple lightweight processes or threads, which are processes that share all or portions of their context (e.g., address space, stack, permissions and/or access restrictions, etc.) with other processes/threads. Thus, a single process may include multiple threads that share, have access to, and/or operate within a single context (e.g., a processor, process, or software application's context).

A multiprocessor system may be configured to execute multiple threads concurrently or in parallel to improve a process's overall execution time. In addition, a software application, operating system, runtime system, scheduler, or another component in the computing system may be configured to create, destroy, maintain, manage, schedule, or execute threads based on a variety of factors or considerations. For example, to improve parallelism, the system may be configured to create a thread for every sequence of operations that could be performed concurrently with another sequence of operations.

Creating and managing threads may require that the computing system perform complex operations that consume a significant amount of time, processor cycles, and device resources (e.g., processing, memory, or battery resources, etc.). As such, software applications that maintain a large number of idle threads, or frequently destroy and create new threads, often have a significant negative or user-perceivable impact on the responsiveness, performance, or power consumption characteristics of the computing device.

To reduce the number of threads that are created and/or maintained by the computing system, a software application or multiprocessor system may be configured to generate, use, and/or maintain a thread pool that includes approximately one thread for each of the available processing units. For example, a four-core processor system may be configured to generate and use a thread pool that maintains four threads—one for each of its four processing cores. A process scheduler or runtime system of the computing device may schedule these threads to execute in any of the available processing cores, which may include physical cores, virtual cores, or a combination thereof. As such, each thread may be a software representation of a physical execution resource (e.g., processing core, etc.) that is provided by the hardware platform of the computing device (e.g., for the execution of a process or software application).

To provide adequate levels of parallelism without requiring the creation or maintenance of a large number of threads, the software application or multiprocessor system may implement or use a task-parallel programming model or solution. Such solutions allow the computing system to split the computation of a software application into tasks, assign the tasks to the thread pool that maintains a near-constant number of threads (e.g., one for each processing unit), and execute assigned tasks via the threads of the thread pool. A process scheduler or runtime system of the computing system may schedule tasks for execution on the processing units, similar to how more conventional solutions schedule threads for execution.

A task may include any procedure, unit of work, or sequence of operations that may be executed in a processing unit via a thread. A task may be process-independent to other tasks, yet dependent on other tasks. For example, a first task may be dependent on another task (i.e., a predecessor task) finishing execution, and other tasks (i.e., successor tasks) may depend on the first task finishing execution. These relationships are known as inter-task dependencies.

Tasks may be unrelated to each other except via their inter-task dependencies. The runtime system of a computing device may be configured to enforce these inter-task dependencies (e.g., by executing tasks after their predecessor tasks have finished execution). A task may finish execution by successfully completing its procedure (i.e., by executing all of its operations) or by being canceled. In an embodiment, the runtime system may be configured to cancel dependent (successor) tasks if a task finishes execution as a result of being canceled.

A task may include state information that identifies whether the task is launched, ready, or finished. In an embodiment, the state information may also identify whether the task is in an “executed” state. A task is in the launched state when it has been assigned to a thread pool and is waiting for a predecessor task to finish execution and/or for other dependencies or prerequisites for execution to be met. A task is in the ready state when all of its dependencies or prerequisites for execution have been met (e.g., all of its predecessors have finished execution), and is waiting to be assigned to the next available thread. A task may be marked as finished after its procedure has been executed by a thread or after being canceled. A task may be marked as executed if the task is dependent on another task finishing execution, includes a “finish_after” statement, and the remaining operations of the task's procedure have previously been executed by a thread.

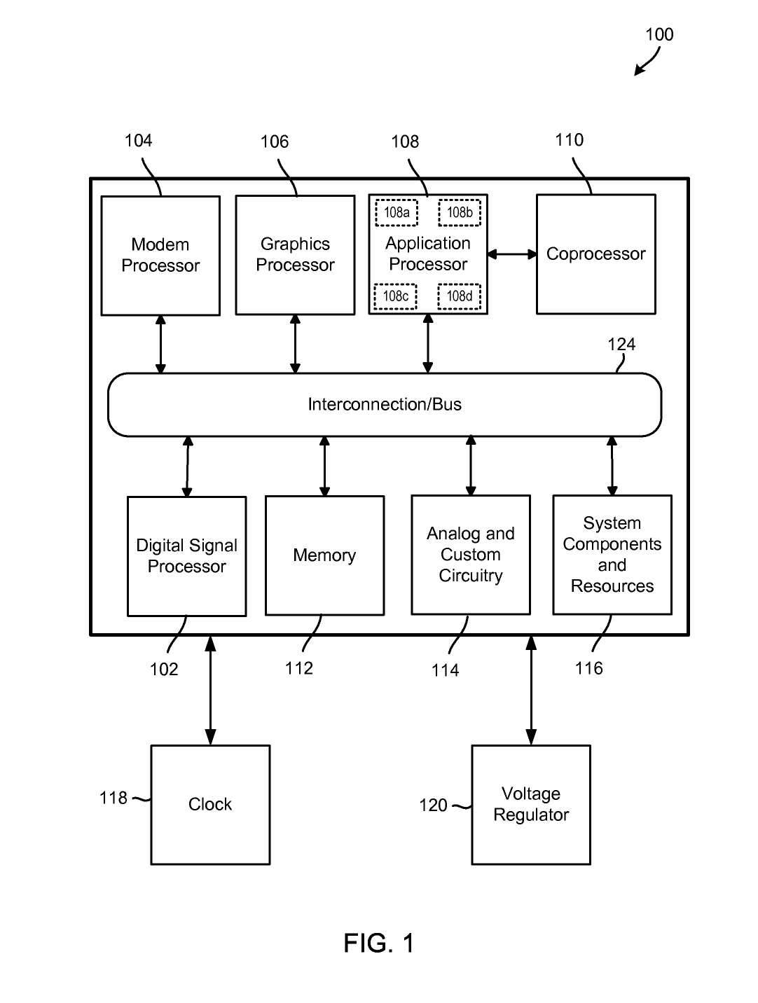

Task-parallel programming solutions may be used to build high-performance software applications that are responsive, efficient, and which otherwise improve the user experience. These software applications may be executed or performed in variety of computing devices and system architectures, an example of which is illustrated in FIG. 1.

FIG. 1 illustrates an example system-on-chip (SOC) 100 architecture that may be included in an embodiment computing device configured to execute run software applications that implement the task-parallel programming model and/or to execute tasks in accordance with the various embodiments. The SOC 100 may include a number of heterogeneous processors, such as a digital signal processor (DSP) 102, a modem processor 104, a graphics processor 106, and an application processor 108. The SOC 100 may also include one or more coprocessors 110 (e.g., vector co-processor) connected to one or more of the heterogeneous processors 102, 104, 106, 108. In an embodiment, the graphics processor 106 may be a graphics processing unit (GPU).

Each processor 102, 104, 106, 108, 110 may include one or more cores (e.g., processing cores 108a, 108b, 108c, and 108d illustrated in the application processor 108), and each processor/core may perform operations independent of the other processors/cores. SOC 100 may include a processor that executes an operating system (e.g., FreeBSD, LINUX, OS X, Microsoft Windows 8, etc.) which may include a scheduler configured to schedule sequences of instructions, such as threads, processes, or data flows, to one or more processing cores for execution.

The SOC 100 may also include analog circuitry and custom circuitry 114 for managing sensor data, analog-to-digital conversions, wireless data transmissions, and for performing other specialized operations, such as processing encoded audio and video signals for rendering in a web browser. The SOC 100 may further include system components and resources 116, such as voltage regulators, oscillators, phase-locked loops, peripheral bridges, data controllers, memory controllers, system controllers, access ports, timers, and other similar components used to support the processors and software programs running on a computing device.

The system components and resources 116 and/or custom circuitry 114 may include circuitry to interface with peripheral devices, such as cameras, electronic displays, wireless communication devices, external memory chips, etc. The processors 102, 104, 106, 108 may communicate with each other, as well as with one or more memory elements 112, system components and resources 116, and custom circuitry 114, via an interconnection/bus module 124, which may include an array of reconfigurable logic gates and/or implement a bus architecture (e.g., CoreConnect, AMBA, etc.). Communications may be provided by advanced interconnects, such as high performance networks-on chip (NoCs).

The SOC 100 may further include an input/output module (not illustrated) for communicating with resources external to the SOC, such as a clock 118 and a voltage regulator 120. Resources external to the SOC (e.g., clock 118, voltage regulator 120) may be shared by two or more of the internal SOC processors/cores (e.g., a DSP 102, a modem processor 104, a graphics processor 106, an application processor 108, etc.).

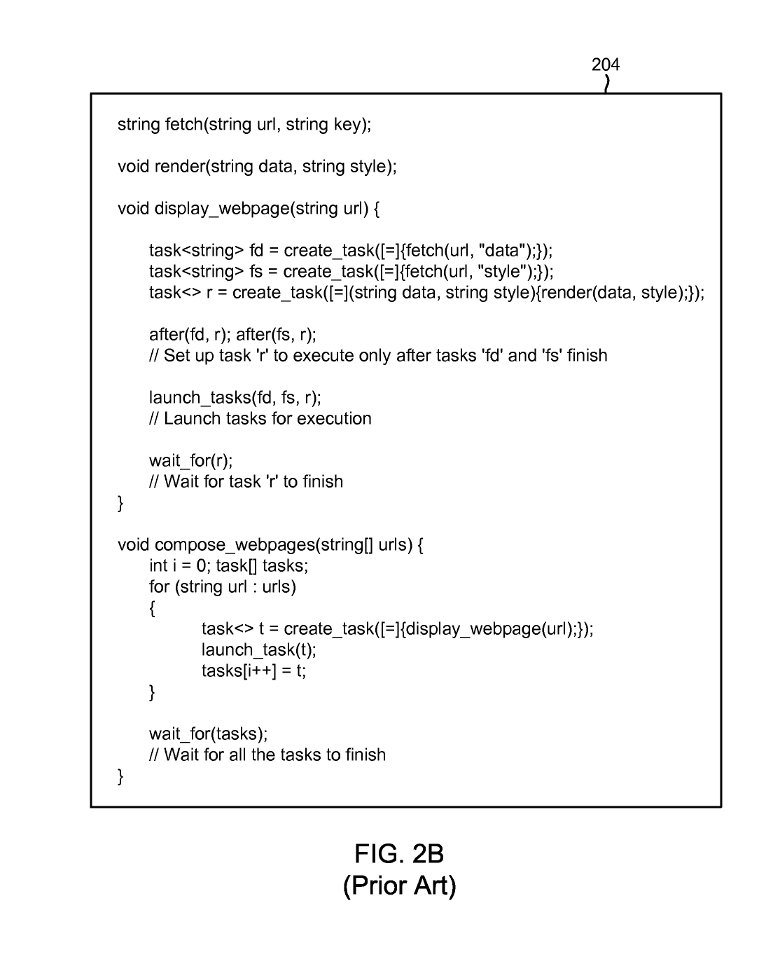

In addition to the SOC 100 discussed above, the various embodiments (including, but not limited to, embodiments discussed below with respect to FIGS. 3-7, 8B, 9A, 9B and 10) may be implemented in a wide variety of computing systems, which may include multiple processors, multicore processors, or any combination thereof.

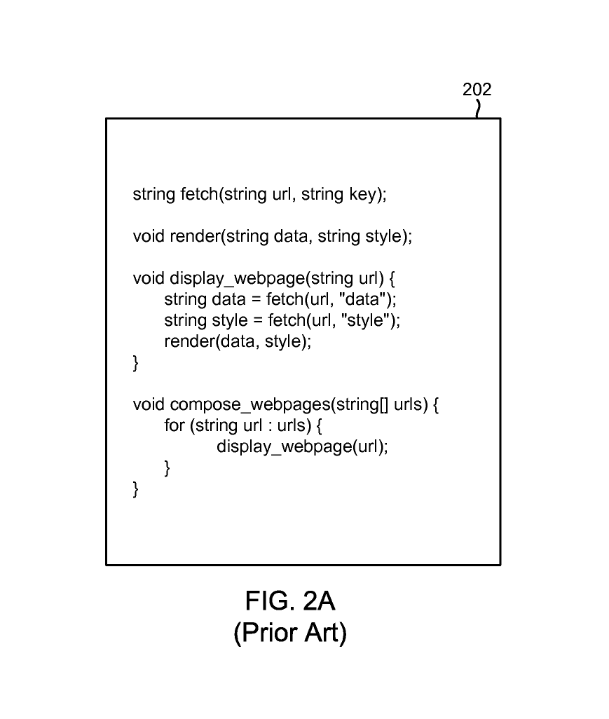

FIGS. 2A through 3 illustrate example solutions for displaying data fetched from many remote sources. Specifically, the examples illustrated in FIGS. 2A-2C are prior art solutions for displaying data fetched from many remote sources. The example illustrated in FIG. 3 is an embodiment solution for displaying data fetched from many remote sources so as to reduce latency and improve the performance and power consumption characteristics of the computing device. It should be understood that these examples are for illustrative purposes only, and should not be used to limit the scope of the claims to fetching or displaying data.

FIGS. 2A through 2C illustrate different prior art procedures 202, 204, 206 for accomplishing the operations of fetching multiple webpages from remote servers and building a composite display of the webpages. Each of these procedures 202, 204, 206 includes functions or sequences of instructions that may be executed by a processing core of a computing device, including a fetch function, a render function, a display_webpage function, and a compose_webpages function.

The procedure 202 illustrated in FIG. 2A is a sequential procedure that performs the operations of the functions one at a time. For example, the compose_webpages function sequentially calls the display_webpage function for each URL in a URL array. By performing these operations sequentially, the illustrated procedure 202 does not exploit the parallel processing capabilities of the computing device.

The procedure 204 illustrated in FIG. 2B implements a conventional task-parallel programming model by splitting some of the functions (modularly) into tasks and identifying task dependencies. For example, FIG. 2B illustrates that the compose_webpages function creates and uses tasks to execute the display_webpage function for each URL in the URL array. Each of these tasks may be executed in parallel with the other tasks (if they have no inter-task dependencies) without creating new threads.

While procedure 204 is an improvement over the sequential procedure 202 (illustrated in FIG. 2A), it does not fully exploit the parallel processing capabilities of the computing device. This is because procedure 204 uses ‘wait_for’ statements to respect the semantics of sequential synchronous function calls and synchronize tasks correctly. The ‘wait_for’ statement blocks task execution until inter-task dependencies are resolved. In addition, the ‘wait_for’ statement couples the point at which a task finishes execution (i.e., is marked as finished) to the point at which the task completes its procedure (executes the last statement).

For example, the display_webpage function of procedure 204 is not marked as finished until ‘wait_for(r)’ statement is finished. This requires that the display_webpage function wait_for task ‘r’ to finish execution before it is marked as finished.

Such waiting may adversely affect the responsiveness of the application (and thus the computing device). The ‘wait_for’ statement blocks the thread executing the task (i.e., by causing the thread to enter a blocked state), which may result in the computing device spawning new threads (i.e., to execute other tasks that are ready for execution). As discussed above, the creation/spawning of a large number of threads may have a negative impact on the performance and power-consumption characteristics of the computing device.

Such waiting is also often an over-specification of the actual desired synchronization among tasks. For example, both display_webpage and compose_webpages functions wait_for tasks. The display_webpage function waits for render tasks (r), and compose_webpages function waits for the display_webpage tasks (tasks). Yet, the tasks on which compose_webpages function should wait are the render tasks (r) inside display_webpage function. However, well-established programming principles (e.g., modularity, implementation-hiding, etc.) require the use of these redundant wait operations, and preclude software designers from specifying the precise amount of synchronization that is required.

For all these reasons, procedure 204 is not an adequate solution for exploiting the parallel processing capabilities of a computing device.

The procedure 206 illustrated in FIG. 2C implements a task-parallel programming model that uses the parent-child relationships among tasks to avoid redundant waiting operations. For example, when the display_webpage function of procedure 206 is invoked inside a task created in the compose_webpages function, any task that it further creates is deemed to be its child task, with the semantics that the display_webpage task finishes only when all its children tasks finish.

Procedure 206 and other task-parallel programming solutions that use the parent-child relationship of tasks are not adequate solutions for exploiting the parallel processing capabilities of a computing device. For example, these solutions constrain programmability because only one task (viz. the parent) can set itself to finish_after other tasks (viz. the children). Further, a parent-child relationship is strictly only between a task that creates another task in a nested fashion, and cannot be defined between two tasks that are created independently of each other. In addition to constraining programmability, these solutions may adversely affect the performance of the device because of the overheads borne by the task-parallel runtime system to track all created tasks as children of the creating task. These overheads may accumulate, and often have a significant negative impact on the performance and responsiveness of the computing device.

FIG. 3 illustrates an embodiment procedure 302 that uses tasks to fetch multiple webpages from remote servers and to build a composite display of multiple webpages. Procedure 302 may be performed by one or more processing units of a multiprocessor system. The code, instructions, and/or statements of procedure 302 are similar to those of procedure 204 (illustrated in FIG. 2B), except that the wait_for statements have been replaced by finish_after statements.

When performing procedure 302, the thread that executes the display_webpage task does not enter the blocked state to wait_for the render task ‘r’ to complete its execution. The thread is therefore free to execute other independent tasks. This is in contrast to procedure 204 (illustrated in FIG. 2B) in which the thread executing the display_webpage task will block at the wait_for operation and/or which may require the creation of new threads to process other independent tasks.

Thus, in contrast to the wait_for statement, the finish_after statement is a non-blocking statement, adds little or no overhead to the runtime system, and allows a software designer to specify the minimum synchronization required for a task to achieve correct execution. The finish_after statement also allows the computing system to perform more fundamental operations on tasks than solutions that use parent-child relationships of tasks (e.g., procedure 206 illustrated in FIG. 2C).

In addition, the finish_after statement may be used to create modular and composable task-parallel programming solutions, and to overcome any or all the above-described limitations of conventional solutions. For example, the ‘finish_after’ statement allows a programmer to programmatically decouple when a task finishes from when its body executes.

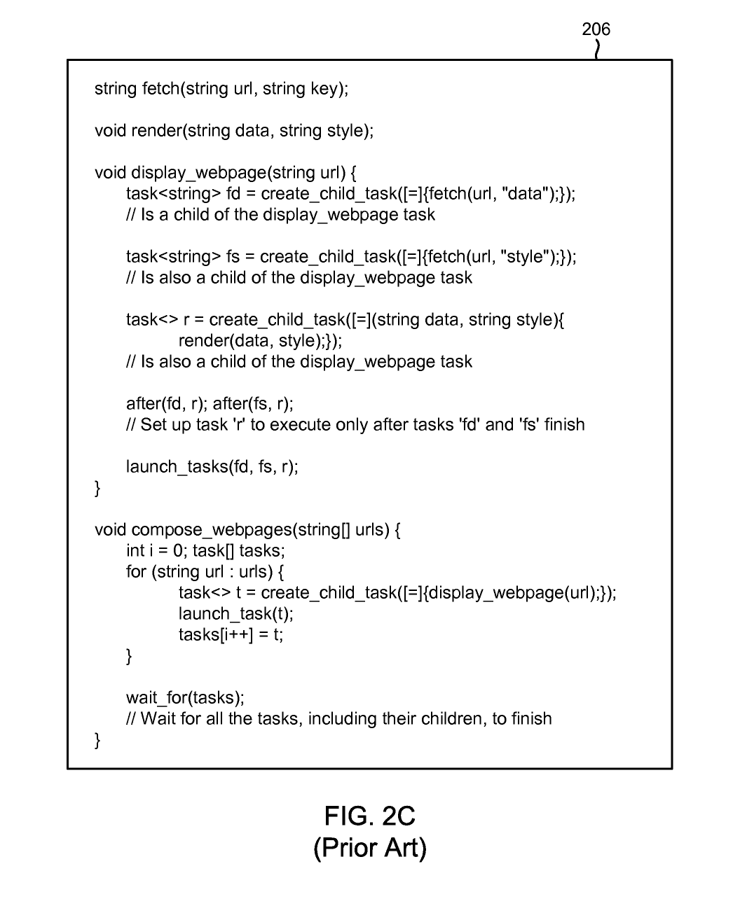

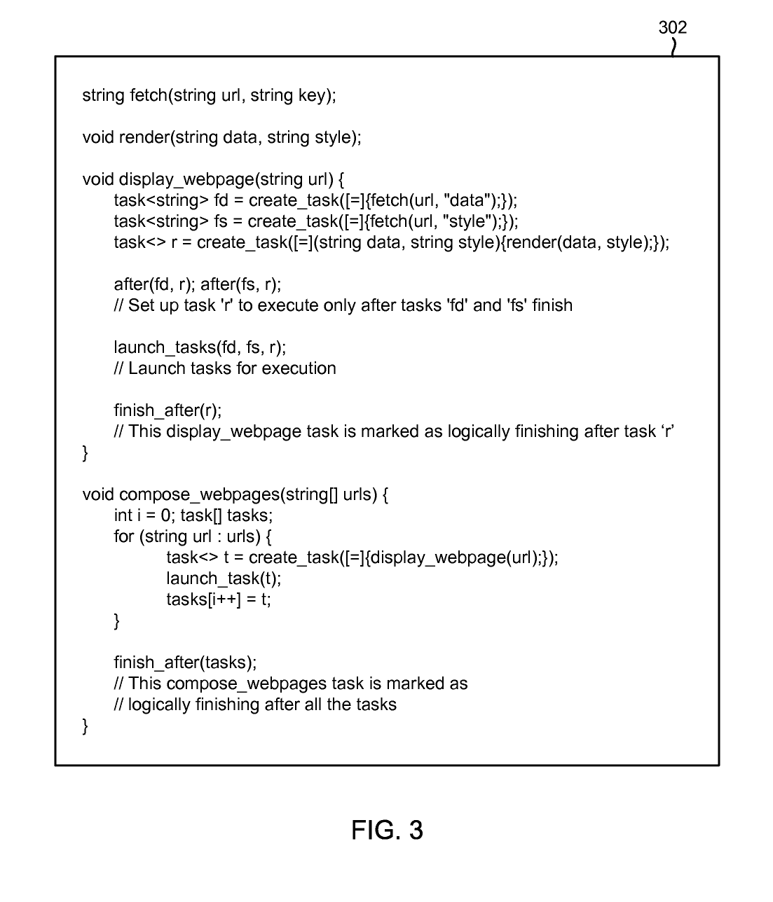

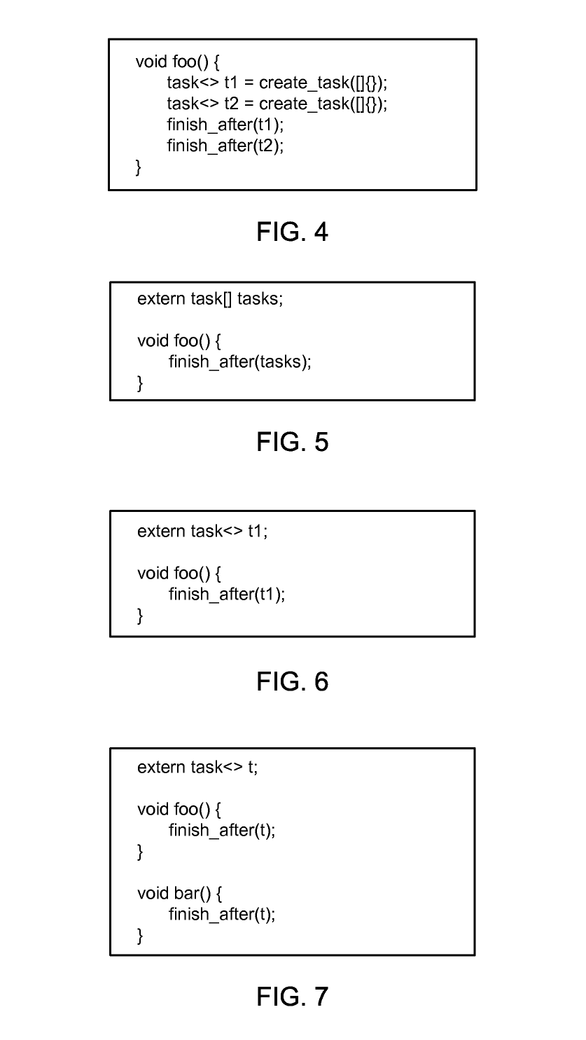

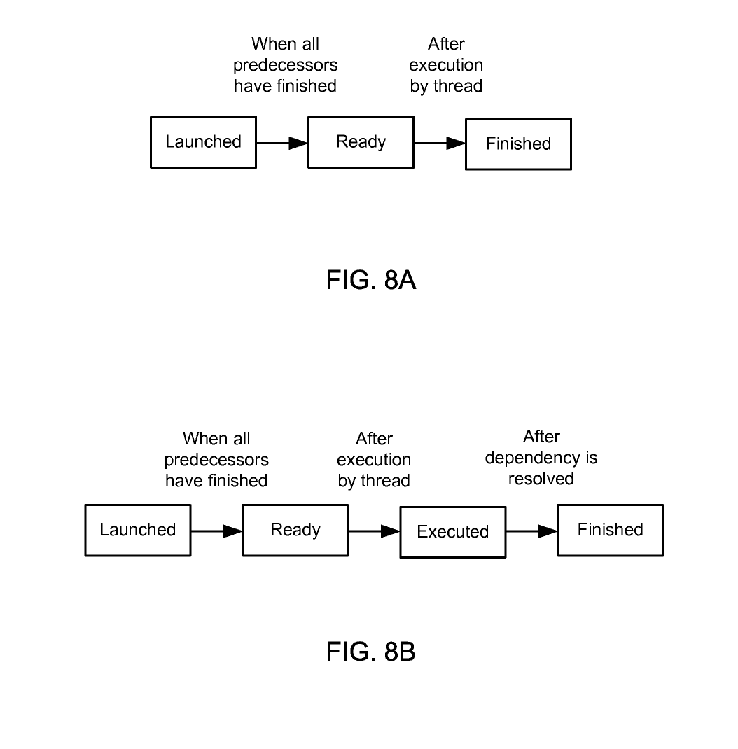

The finish_after statement also empowers the programmer to relate tasks to each other in several useful ways. For example, FIG. 4 illustrates that the finish_after statement may be used to identify a task as finishing after multiple tasks. As another example, FIG. 5 illustrates that the finish_after statement may be used to identify a task as finishing after a group of tasks. As a further example, FIG. 6 illustrates that the finish_after statement may be used to identify a current task as finishing after tasks that were not created or spawned by the current task. As a further example, FIG. 7 illustrates that the finish_after statement may be used by multiple tasks to identify that they finish after the same task. These and other capabilities provided by the finish_after statement and its corresponding operations are fundamentally new capabilities not provided by conventional solutions (e.g., solutions that exploit the parent-child relationship of tasks, etc.), and that have the potential to improve the functioning and performance of computing devices implementing software using the statement.

The ‘finish_after’ statement may also be used by a computing system to better implement the parent-child relationship among tasks. For example, when a first task (task A) creates a second task (task B), the runtime system can internally mark the first task (task A) as finishing after the second task (e.g., via a finish_after(B) operation). The first task (task A) will finish after the second task (task B) finishes, giving the exact same semantics as those provided by the parent-child relationship.

The ‘finish_after’ operation, in combination with task dependencies, enables a style of high-performance parallel programming called continuation-passing style (CPS). CPS is a non-blocking parallel programming style known for its high performance. However, it is challenging to develop CPS solutions without compiler support. The ‘finish_after’ operation addresses this problem and allows programmers to write CPS parallel programs more easily and in a modular and composable manner.

By using finish_after statement, a software designer is able to express parallelism in the task-parallel programming model in a modular and composable manner, while extracting maximum performance from the parallel hardware. Referring to FIG. 3, the display_webpage function is parallelized completely independently of the compose_webpages function, and maximum parallelism and minimum synchronization is conveniently specified.

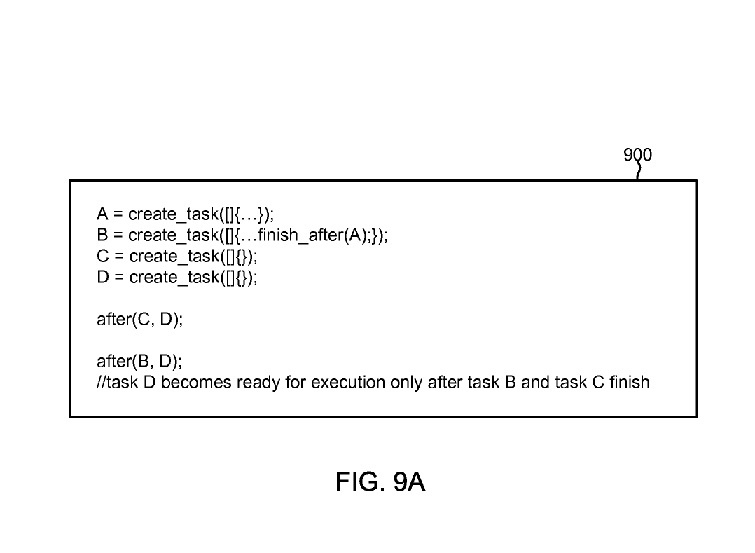

FIG. 8A illustrates state transitions for a task that does not include a finish_after statement. Specifically, FIG. 8A illustrates that the task transitions from the launched state to the ready state when all of its predecessors have finished execution. The task then transitions from the ready state to the finished state after its procedure is executed by a thread.

FIG. 8B illustrates state transitions for a task that includes a finish_after statement. The task transitions from the launched state to the ready state when all of its predecessors have finished execution. The task transitions from the ready state to an executed state when the thread performs the finish_after statement. The task transitions from the executed state to the finished state after all of its dependencies introduced through finish_after statements have been resolved.

In other embodiments, there may not be a physical or literal “executed” state. Rather, the transition out of the ready state and into the finished state may occur only after all of the dependencies introduced through finish_after statements have been resolved.

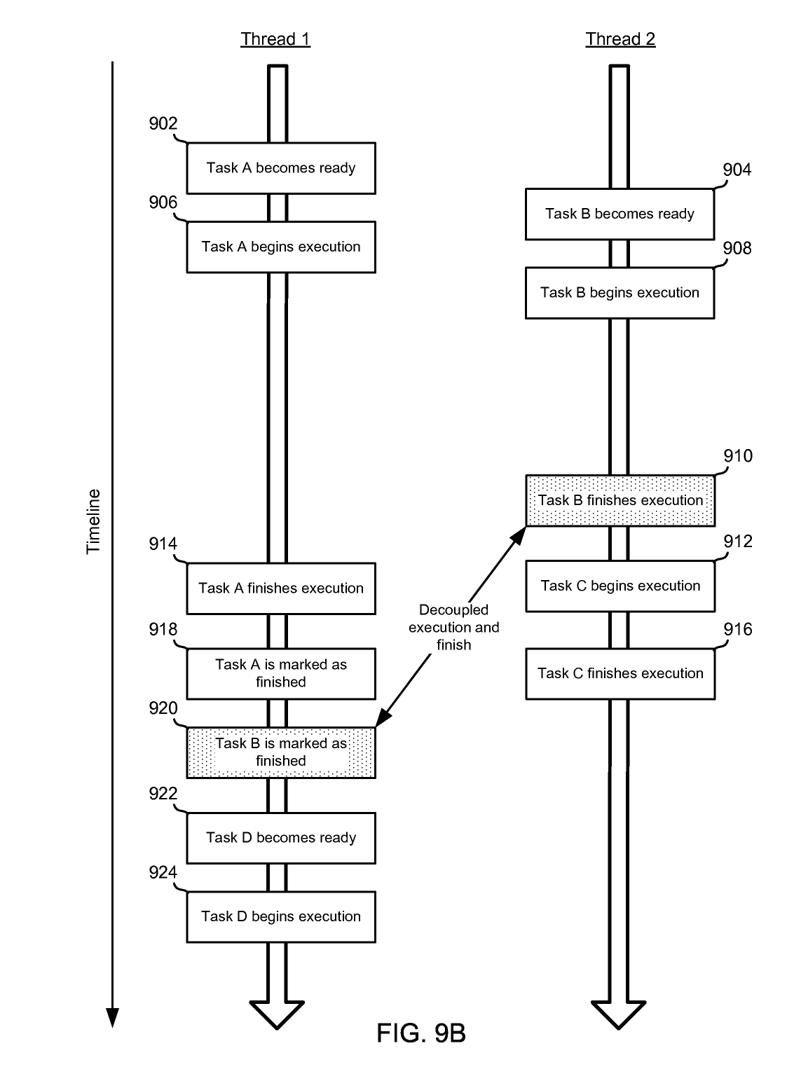

FIG. 9A illustrates a procedure 900 that uses the finish_after statement so as to decouple task execution from task finish in accordance with the various embodiments. Procedure 900 creates four tasks (Tasks A-D). Task B includes a finish_after statement that indicates it will not be completely finished until Task A finishes execution. Task D is dependent on tasks C and B, and thus becomes ready for execution after task B is marked as finished.

FIG. 9B is an illustration of a timeline of executing the tasks of procedure 900 via a first thread (Thread 1) and a second (Thread 2). In block 902, task A becomes ready for execution. In block 904, task B becomes ready for execution. In block 906, task A begins execution via the first thread. In block 908, task B begins execution via the second thread.

In block 910, task B finishes executing its procedure, including the finish_after(A) statement. In an embodiment, when task B executes the statement finish_after(A) in block 910, the runtime system creates a dummy task (e.g., a stub task) and a dependency from task A to the dummy task. In another embodiment, in block 910 the runtime system may mark task B as “executed” in response to task B finishes executing its procedure. In any case, task B completes its execution prior to task A completing its execution despite task B's dependency on task A. This allows the second thread to begin executing task C in block 912 prior to task B being marked as finished.

In block 914 task A finishes execution. In block 916 task C finishes execution. In block 918, task A is marked as finished. In block 920 task B is marked as finished (since its dependency on task A's completion has been resolved). In an embodiment, when task A finishes execution in block 914, the stub task is executed in block 920 by the runtime system so the stub task transitions task B to the finished state. In block 922 task D becomes ready (since its dependencies on tasks C and B have been resolved). In block 924 task D begins execution.

While in many instances the first and second tasks will be from different threads, there are cases in which the first and second tasks may be part of the same thread. An example of such an instance is illustrated in the following sequence:

task A = create_task([ ] { });
task B = create_task([&] {finish_after(A);});
launch(A);
launch(B).

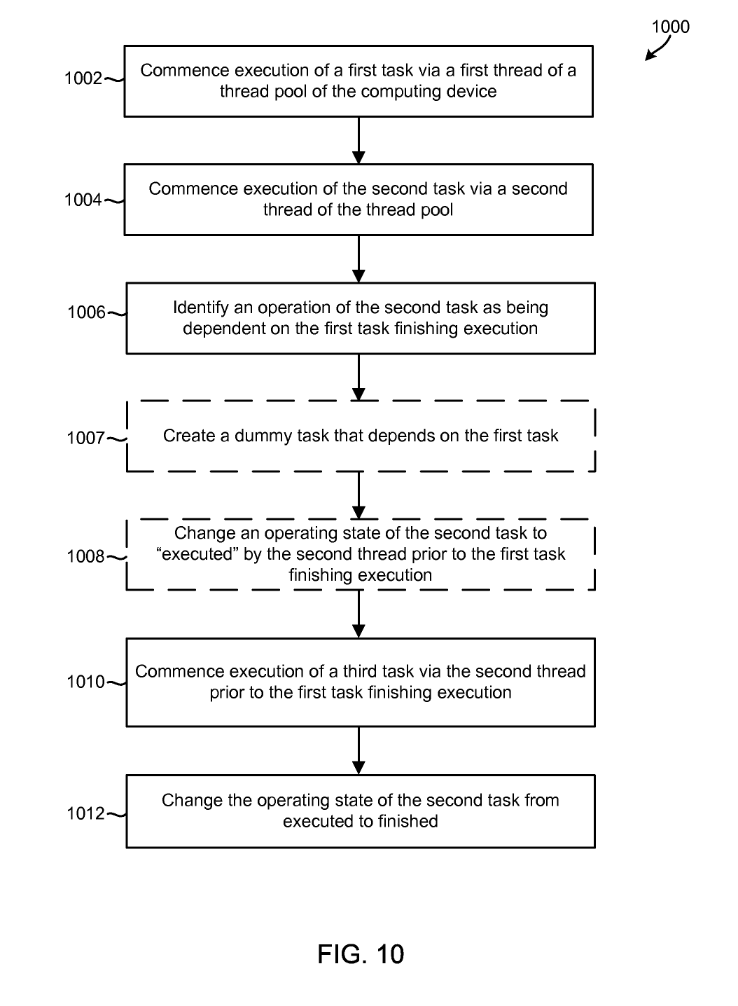

FIG. 10 illustrates a method 1000 of executing tasks in a computing device according to various embodiments. Method 1000 may be performed by one or more processing cores of the computing device. In block 1002, the processing core may commence execution of a first task via a first thread of a thread pool of the computing device. In block 1004, the same or different processing core may commence execution of the second task via a second thread of the thread pool. In an embodiment, the commencing execution of the first task in block 1002 includes executing the first task in a first processing core of the computing device, and commencing execution of the second task in block 1004 includes executing the second task in a second processing core of the computing device concurrent with the first task.

In block 1006, the processing core may identify an operation of the second task (e.g., a finish_after operation) as being dependent on the first task finishing execution. In optional block 1007, the processing core may create a dummy task that depends on the first task. In optional block 1008, the processing core may change an operating state of the second task to “executed” via the second thread in response to identifying the operation (e.g., the finish_after operation), after completing all other operations of the second task, and prior to the first task finishing execution. In block 1010, the processing core may commence execution of a third task via the second thread prior to the first task finishing execution. In block 1012, the processing core may change the operating state of the second task from executed to finished by the first thread in response to determining that the first task has finished execution. In an embodiment, this may be accomplished by creating/executing the dummy task to cause the second task transition to the finished state. For example, the processing core may create a dummy task that depends on the first task in response to the second thread performing a finish_after operation of the second task. In an embodiment, the dummy task may perform a programmer-supplied function specified via a parameter of the finish_after operation. The dummy task may also perform/execute multiple programmer-supplied functions corresponding to multiple finish_after operations in the task, one of which is the programmer-supplied function specified via the parameter that causes the second task to transition to the finished state.

In a further embodiment, the processing core may be configured to launch a fourth task that is dependent on the second and third tasks. The processing core may commence execution of the fourth task via the first thread in response to changing the operating state of the second task from “executed” to “finished.”

In an embodiment, the processing core may be configured so that the ‘finish_after’ statement accepts a function as a parameter (e.g., as a second parameter). For example, the statement “finish_after(A, fn)” may indicate that the invoking task will not be completely finished until Function fn is executed, and that Function fn will be executed after Task A finishes execution. As a more detailed example, consider the following synchronous APIs:

B f1 (A a);
// Function f1 that takes a value of type A and
// returns a value of type B
C f2 (B b);
// Function f2 that takes a value of type B and
// returns a value of type C

The two functions (i.e., f1 and f2) may be composed synchronously as back-to-back sequential function calls. For example, the function may be composed as follows:

C c = f2(f1(a));
// Composed function f2.f1 that takes a value of type a and
// returns a value of type C

The two functions may be composed asynchronously through task dataflow, such as:

task<B> t1 = create_task(f1, a);
task<C> t2 = create_task(f2);
t1 >>= t2;
// >>= indicates dataflow from task t1 to t2
launch_tasks(t1, t2);
// Launch tasks for execution
C c = t2.get_value( );
// Waits for t2 to finish and retrieves value of type C

The processing core may implement the actual dataflow (after task t1 finishes execution) as follows:

```
void execute( )
{
  B b = f1(a);
  for_each(auto successor: this->dataflow_successors)
  {
    successor.set_arg(b);
    // Set argument of each dataflow successor to be b
  }
}
```

Yet, when the APIs are asynchronous, the processing core may implement the actual dataflow as follows:

task<B> f1(A a);
// Function f1 that takes a value of type A and
// returns a task of type B
task<C> f2(B b);
// Function f2 that takes a value of type B and
// returns a task of type C

Functions f1 and f2 should eventually (at an arbitrary time in the future) materialize values of types B and C. Yet, the synchronous APIs return values of types B and C as soon as the function calls return. For example, the two asynchronous functions above may be composed asynchronously as follows:

task<B> t1 = create_task(f1, a);
task<C> t2 = create_task(f2);
t1 >>= t2;
// >>= indicates dataflow from task t1 to t2
launch_tasks(t1, t2);
// Launch tasks for execution
C c = t2.get_value( );
// Waits for t2 to finish and retrieves value of type C

In the above example, the processing core/computing device may not be able to implement the actual dataflow the same as before (i.e., the same as it would synchronously for the back-to-back sequential function calls). For instance, the “execute” method/function/procedure discussed above would become:

```
void execute( )
{
  task<B> b = f1(a);
  // At this point, result of type B is not yet available.
}
```

In such cases/scenarios, an embodiment computing device could use the finish_after statement could be used to implement the dataflow. For example, the computing device could implement the dataflow as follows:

```
void execute( )
{
  task<B> tb = f1(a);
  auto fn = [this, tb]
  {
    for_each(auto successor: this->dataflow_successors)
    {
      successor. set_arg(b.get_value( ));
    }
  };
  finish_after(tb, fn);
}
```

In the above-example, the finish_after statement/operation includes a second argument (i.e., function fn) that will be executed after the task on which the current task is set to finish_after finishes (i.e., after task tb finishes).

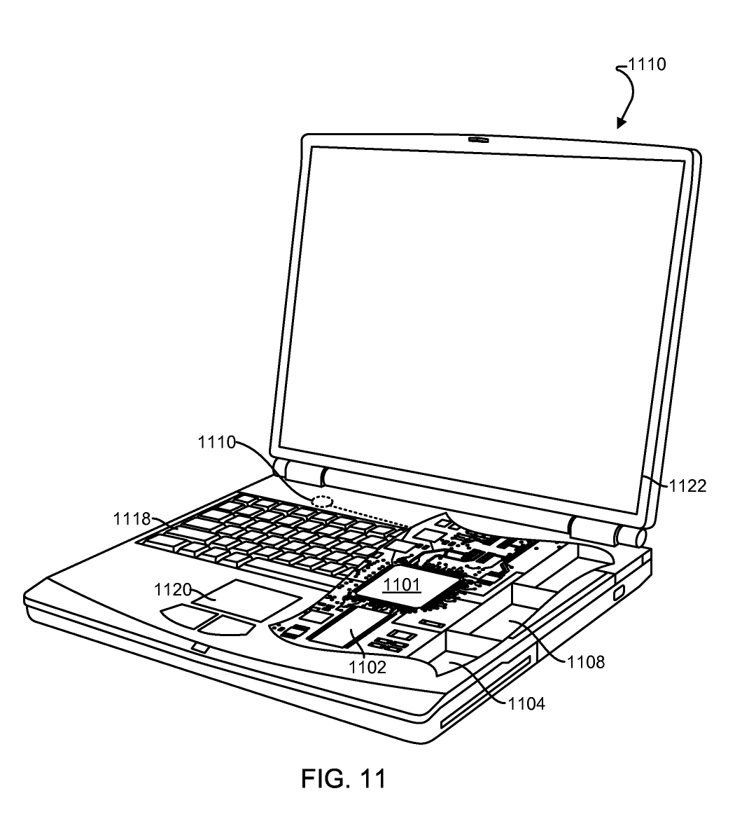

The various embodiments (including but not limited to embodiments discussed above with respect to FIGS. 1, 3-7, 8B, 9A, 9B and 10) may be implemented on a variety of computing devices, examples of which are illustrated in FIGS. 11-13.

Computing devices will have in common the components illustrated in FIG. 11, which illustrates an example personal laptop computer 1100. Such a personal computer 1100 generally includes a multi-core processor 1101 coupled to volatile memory 1102 and a large capacity nonvolatile memory, such as a disk drive 1104. The computer 1100 may also include a compact disc (CD) and/or DVD drive 1108 coupled to the processor 1101. The personal laptop computer 1100 may also include a number of connector ports coupled to the processor 1101 for establishing data connections or receiving external memory devices, such as a network connection circuit for coupling the processor 1101 to a network. The personal laptop computer 1100 may have a radio/antenna 1110 for sending and receiving electromagnetic radiation that is connected to a wireless data link coupled to the processor 1101. The computer 1100 may further include keyboard 1118, a pointing a mouse pad 1120, and a display 1122 as is well known in the computer arts. The multi-core processor 1101 may include circuits and structures similar to those described above and illustrated in FIG. 1.

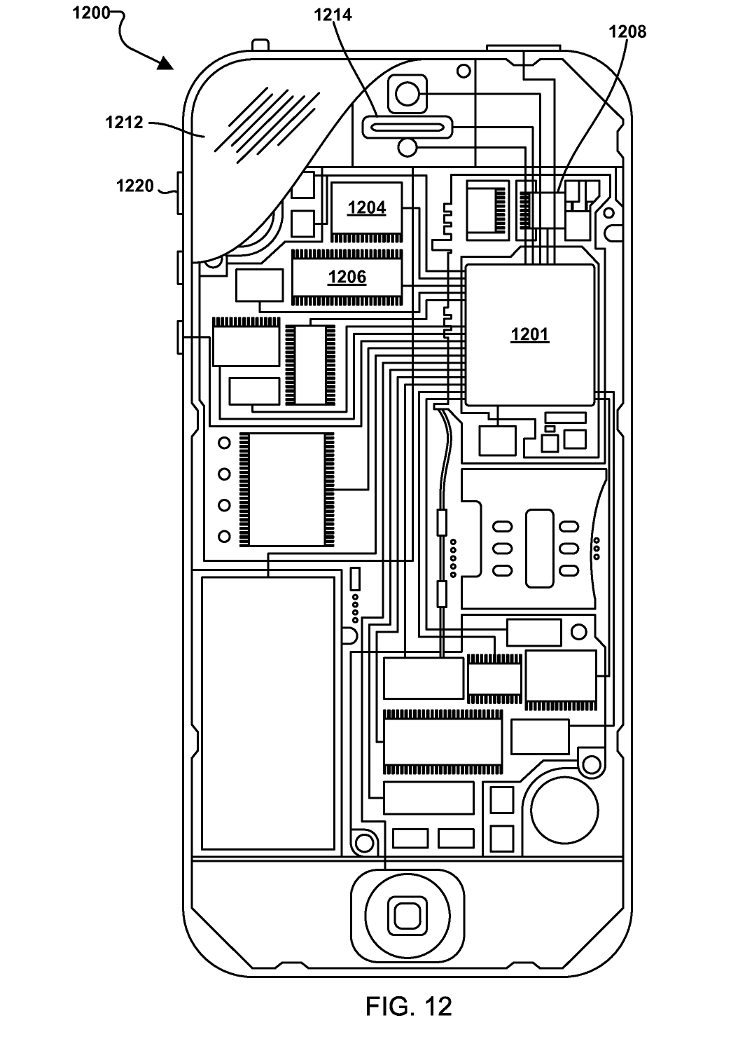

FIG. 12 illustrates a smartphone 1200 that includes a multi-core processor 1201 coupled to internal memory 1204, a display 1212, and to a speaker 1214. Additionally, the smartphone 1200 may include an antenna for sending and receiving electromagnetic radiation that may be connected to a wireless data link and/or cellular telephone transceiver 1208 coupled to the processor 1201. Smartphones 1200 typically also include menu selection buttons or rocker switches 1220 for receiving user inputs. A typical smartphone 1200 also includes a sound encoding/decoding (CODEC) circuit 1206, which digitizes sound received from a microphone into data packets suitable for wireless transmission and decodes received sound data packets to generate analog signals that are provided to the speaker to generate sound. Also, one or more of the processor 1201, transceiver 1208 and CODEC 1206 may include a digital signal processor (DSP) circuit (not shown separately).

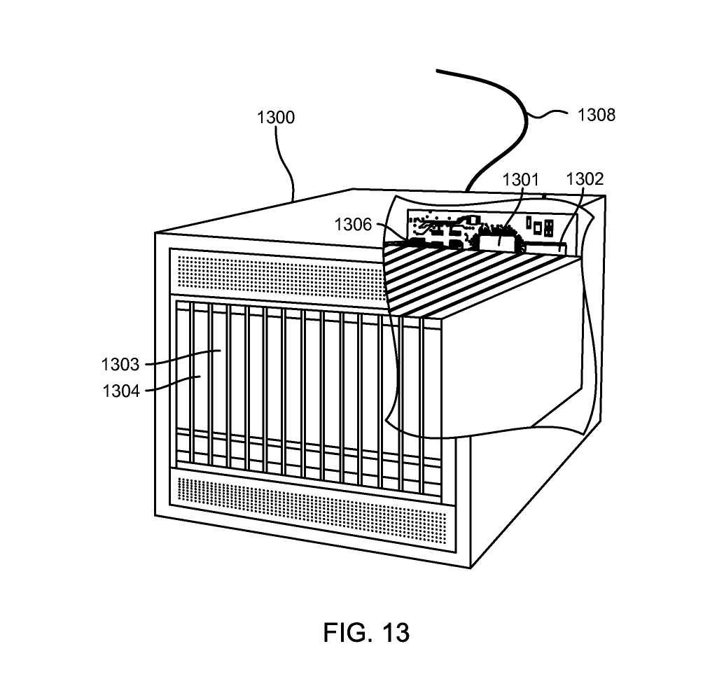

The various embodiments may also be implemented on any of a variety of commercially available server devices, such as the server 1300 illustrated in FIG. 13. Such a server 1300 typically includes multiple processor systems one or more of which may be or include a multi-core processor 1301. The processor 1301 may be coupled to volatile memory 1302 and a large capacity nonvolatile memory, such as a disk drive 1303. The server 1300 may also include a floppy disc drive, compact disc (CD) or DVD disc drive 1304 coupled to the processor 1301. The server 1300 may also include network access ports 1306 coupled to the processor 1301 for establishing data connections with a network 1308, such as a local area network coupled to other broadcast system computers and servers.

The processors 1101, 1201, 1301 may be any programmable multi-core multiprocessor, microcomputer or multiple processor chips that can be configured by software instructions (applications) to perform a variety of functions, including the functions and operations of the various embodiments described herein. Multiple processors may be provided, such as one processor dedicated to wireless communication functions and one processor dedicated to running other applications. Typically, software applications may be stored in the internal memory 1102, 1204, 1302 before they are accessed and loaded into the processor 1101, 1201, 1301. In some mobile computing devices, additional memory chips (e.g., a Secure Data (SD) card) may be plugged into the mobile device and coupled to the processor 1101, 1201, 1301. The internal memory 1102, 1204, 1302 may be a volatile or nonvolatile memory, such as flash memory, or a mixture of both. For the purposes of this description, a general reference to memory refers to all memory accessible by the processor 1101, 1201, 1301, including internal memory, removable memory plugged into the mobile device, and memory within the processor 1101, 1201, 1301 itself.

Computer program code or “code” for execution on a programmable processor for carrying out operations of the various embodiments may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used herein refer to machine language code (such as object code) whose format is understandable by a processor.

Computing devices may include an operating system kernel that is organized into a user space (where non-privileged code runs) and a kernel space (where privileged code runs). This separation is of particular importance in Android® and other general public license (GPL) environments where code that is part of the kernel space must be GPL licensed, while code running in the user-space may not be GPL licensed. It should be understood that the various software components discussed in this application may be implemented in either the kernel space or the user space, unless expressly stated otherwise.

As used in this application, the terms “component,” “module,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core, and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

The foregoing method descriptions and the process flow diagrams are provided merely as illustrative examples and are not intended to require or imply that the blocks of the various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of executing tasks in a computing device, comprising:
commencing execution of a first task via a first thread of a thread pool in the computing device;
commencing execution of a second task via a second thread of the thread pool;
identifying an operation of the second task as being dependent on the first task finishing execution;
commencing execution of a third task via the second thread prior to the first task finishing execution; and
changing an operating state of the second task to finished by the first thread in response to determining that the first task has finished execution.

2. The method of claim 1, further comprising:
changing the operating state of the second task to executed by the second thread in response to identifying the operation prior to commencing execution of the third task and prior to changing the operating state of the second task to finished.

3. The method of claim 2, wherein changing the operating state of the second task to executed in response to identifying the operation prior to commencing execution of the third task and prior to changing the operating state of the second task to finished comprises:
changing the operating state of the second task in response to determining that the second task includes a finish_after operation and after completing all other operations of the second task.

4. The method of claim 1, further comprising:
creating a dummy task that depends on the first task in response to the second thread performing a finish_after operation of the second task.

5. The method of claim 4, wherein the dummy task performs a programmer-supplied function specified via a parameter of the finish_after operation.

6. The method of claim 1, further comprising:
launching a fourth task that is dependent on the second task; and
commencing execution of the fourth task via the first thread in response to identifying the operation.

7. The method of claim 1, wherein:
commencing execution of the first task via the first thread of the thread pool comprises executing the first task in a first processing core of the computing device; and
commencing execution of the second task via the second thread of the thread pool comprises executing the second task in a second processing core of the computing device concurrent with execution of the first task in the first processing core.

8. The method of claim 1, wherein the first and second threads are different threads.

9. A computing device, comprising:
one or more processors configured with processor-executable instructions to perform operations comprising:
commencing execution of a first task via a first thread of a thread pool;
commencing execution of a second task via a second thread of the thread pool;
identifying an operation of the second task as being dependent on the first task finishing execution;
commencing execution of a third task via the second thread prior to the first task finishing execution; and
changing an operating state of the second task to finished by the first thread in response to determining that the first task has finished execution.

10. The computing device of claim 9, wherein the one or more processors are configured with processor-executable instructions to perform operations further comprising:
changing the operating state of the second task to executed by the second thread in response to identifying the operation prior to commencing execution of the third task and prior to changing the operating state of the second task to finished.

11. The computing device of claim 10, wherein the one or more processors are configured with processor-executable instructions to perform operations such that changing the operating state of the second task to executed in response to identifying the operation prior to commencing execution of the third task and prior to changing the operating state of the second task to finished comprises:
changing the operating state of the second task in response to determining that the second task includes a finish_after operation and after completing all other operations of the second task.

12. The computing device of claim 9, wherein the one or more processors are configured with processor-executable instructions to perform operations further comprising:
creating a dummy task that depends on the first task in response to the second thread performing a finish_after operation of the second task.

13. The computing device of claim 12, wherein the one or more processors are configured with processor-executable instructions to perform operations such that the dummy task performs a programmer-supplied function specified via a parameter of the finish_after operation.

14. The computing device of claim 9, wherein the one or more processors are configured with processor-executable instructions to perform operations further comprising:
launching a fourth task that is dependent on the second task; and
commencing execution of the fourth task via the first thread in response to identifying the operation.

15. The computing device of claim 9, wherein the one or more processors are configured with processor-executable instructions to perform operations such that:
commencing execution of the first task via the first thread of the thread pool comprises executing the first task in a first processor of the computing device; and
commencing execution of the second task via the second thread of the thread pool comprises executing the second task in a second processor of the computing device concurrent with execution of the first task in the first processing core.

16. The computing device of claim 9, wherein the one or more processors are configured with processor-executable instructions to perform operations such that the first and second threads are different threads.

17. A non-transitory computer readable storage medium having stored thereon processor-executable software instructions configured to cause one or more processors in a computing device to perform operations comprising:
commencing execution of a first task via a first thread of a thread pool;
commencing execution of a second task via a second thread of the thread pool;
identifying an operation of the second task as being dependent on the first task finishing execution;
commencing execution of a third task via the second thread prior to the first task finishing execution; and
changing an operating state of the second task to finished by the first thread in response to determining that the first task has finished execution.

18. The non-transitory computer readable storage medium of claim 17, wherein the stored processor-executable software instructions are configured to cause one or more processors to perform operations comprising:
changing the operating state of the second task to executed by the second thread in response to identifying the operation prior to commencing execution of the third task and prior to changing the operating state of the second task to finished.

19. The non-transitory computer readable storage medium of claim 18, wherein the stored processor-executable software instructions are configured to cause one or more processors to perform operations such that changing the operating state of the second task to executed in response to identifying the operation prior to commencing execution of the third task and prior to changing the operating state of the second task to finished comprises:
changing the operating state of the second task in response to determining that the second task includes a finish_after operation and after completing all other operations of the second task.

20. The non-transitory computer readable storage medium of claim 17, wherein the stored processor-executable software instructions are configured to cause one or more processors to perform operations comprising:
creating a dummy task that depends on the first task in response to the second thread performing a finish_after operation of the second task.

21. The non-transitory computer readable storage medium of claim 20, wherein the stored processor-executable software instructions are configured to cause one or more processors to perform operations such that the dummy task performs a programmer-supplied function specified via a parameter of the finish_after operation.

22. The non-transitory computer readable storage medium of claim 17, wherein the stored processor-executable software instructions are configured to cause one or more processors to perform operations comprising:
launching a fourth task that is dependent on the second task; and
commencing execution of the fourth task via the first thread in response to identifying the operation.

23. The non-transitory computer readable storage medium of claim 17, wherein the stored processor-executable software instructions are configured to cause one or more processors to perform operations such that:
commencing execution of the first task via the first thread of the thread pool comprises executing the first task in a first processing core of the computing device; and
commencing execution of the second task via the second thread of the thread pool comprises executing the second task in a second processing core of the computing device concurrent with execution of the first task in the first processing core.

24. The non-transitory computer readable storage medium of claim 17, wherein the stored processor-executable software instructions are configured to cause one or more processors to perform operations such that the first and second threads are different threads.

25. A method comprising:
compiling software code, the software code including:
first code defining a first task;
second code defining a second task; and
a statement that makes an operation of the second task dependent on the first task finishing execution, but enables a thread that commences execution of the second task to commence execution of a third task prior to the first task finishing execution.

26. The method of claim 25, further comprising executing the compiled software code.

27. The method of claim 26, wherein executing the compiled software code comprises executing the first code in a first processing core of a computing device and executing the second code in a second processing core of the computing device concurrent with execution of the first task in the first processing core.

28. The method of claim 26, wherein executing the compiled software code comprises executing the first task via a first thread of a thread pool in a computing device and executing the second task via a second thread of the thread pool.

29. The method of claim 28, wherein the first and second threads are different threads.
